(19) United States
(12) Patent Application Publication
(10) Pub. No.: US 2024/0184117 A1
(43) Pub. Date: Jun. 6, 2024

(54) Optical Systems For Directing Display Module Light into Waveguides

(71) Applicant: Apple Inc., Cupertino, CA (US)

(72) Inventors: Scott M. DeLapp, San Diego, CA (US); Vikrant Bhakta, Santa Clara, CA (US); Di Hu, Mountain View, CA (US); Guolin Peng, Sunnyvale, CA (US); Darshan R Kasar, Redwood City, CA (US); John Raff, Menlo Park, CA (US)

(21) Appl. No.: 18/440,812

(22) Filed: Feb. 13, 2024

Related U.S. Application Data
(63) Continuation of application No. PCT/US22/41249, filed on Aug. 23, 2022.
(60) Provisional application No. 63/240,277, filed on Sep. 2, 2021.

(51) Int. Cl. G02B 27/01; G02B 6/34

(52) U.S. Cl. CPC G02B 27/0172; G02B 6/34; G02B 2027/0174

(57) ABSTRACT

A display system may include a waveguide, an input coupler with a first surface relief grating (SRG), and an output coupler with a second SRG. A display module may produce image light that is coupled into the waveguide by the first SRG. The first SRG may have an input vector non-parallel with respect to a normal axis of the waveguide. The display module may have an optical axis tilted with respect to the input vector by a non-zero angle. A prism may redirect the image light from the module to the first SRG in a direction parallel to the input vector. The module may include lens elements with an optical axis offset with respect to the center of the field of the image light. This may cause the lens elements to output the image light in a direction parallel to the input vector of the first SRG.

This application is a continuation of international patent application No. PCT/US2022/041249, filed Aug. 23, 2022, which claims priority to U.S. provisional patent application No. 63/240,277, filed Sep. 2, 2021, which are hereby incorporated by reference herein in their entireties.

### BACKGROUND

This disclosure relates generally to optical systems and, more particularly, to optical systems for electronic devices with displays.

Electronic devices often include displays that present images close to a user's eyes. For example, virtual and augmented reality headsets may include displays with optical elements that allow users to view the displays.

Devices such as these can be challenging to design. If care is not taken, the components used to display images in these devices can be unsightly, bulky, or uncomfortable, and may not exhibit a desired optical performance.

### SUMMARY

An electronic device may have a display system. The display system may include a waveguide, an input coupler, and an output coupler. The input coupler may include a first surface relief grating (SRG). The output coupler may include a second SRG. A display module may produce image light that is coupled into the waveguide by the first SRG and that is coupled out of the waveguide by the second SRG. The waveguide may have a lateral surface with a normal axis.

The first SRG may be characterized by an input vector that is non-parallel with respect to the normal axis. The display module may have an optical axis tilted with respect to the input vector by a non-zero angle. An achromatic prism may be optically interposed between the display module and the first SRG. The achromatic prism may redirect the image light from the display module to the first SRG in a direction parallel to the input vector. The achromatic prism may include first and second optical wedges formed from different materials to mitigate dispersion. This may allow the display module to be placed within a housing for the device without uncomfortably interfering with wear of the device by a user, without sacrificing optical performance.

If desired, the display module may include collimating optics that transmit the image light to the first SRG. The collimating optics may include lens elements. The lens elements may have an aligned optical axis that is offset with respect to the center of the field of the image light. This may cause the collimating optics to output the image light in a direction parallel to the input vector of the first SRG. If desired, portions of the lens elements that are not used to transmit the image light may be trimmed or removed to conserve space and weight. Configuring the collimating optics in this way may additionally or alternatively serve to mitigate the production of ghost artifacts due to higher order diffractive modes of the first SRG reflecting light off of pixels in the display module.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with optical couplers in accordance with some embodiments.

FIGS. 3A-3C are top views of illustrative a waveguide provided with a surface relief grating structure in accordance with some embodiments.

FIG. 4 is a top view of an illustrative waveguide having an input coupling surface relief grating that receives image light at an input angle and an output coupling surface relief grating that couples the image light out of the waveguide at an output angle equal to the input angle in accordance with some embodiments.

FIG. 5 is a top view of an illustrative display having a prism that redirects image light output by a display module onto an angle that matches an input vector of an input coupling surface relief grating on a waveguide in accordance with some embodiments.

FIG. 6 is a top view of an illustrative display module having collimating optics that align image light with a field of view of a display in accordance with some embodiments.

FIG. 7 is a diagram showing how collimating optics in a display module may be offset to direct image light onto an input coupling surface relief grating at an angle that matches the input vector of the input coupling surface relief grating in accordance with some embodiments.

FIG. 8 is a diagram showing how offset collimating optics in a display module may mitigate ghost image production in an optical system in accordance with some embodiments.

FIG. 9 is a top view of showing how a prism of the type shown in FIG. 5 may include a single optical wedge with reflective and transmissive surfaces that redirect image light in accordance with some embodiments.

### DETAILED DESCRIPTION

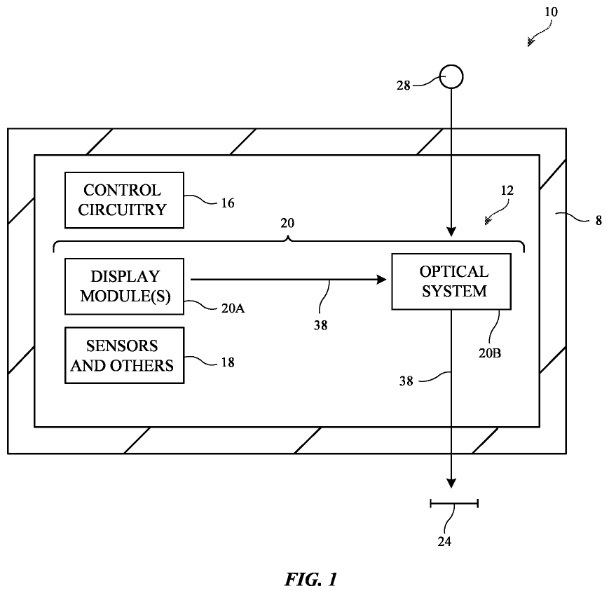

System 10 of FIG. 1 may be a head-mounted device having one or more displays. The displays in system 10 may include near-eye displays 20 mounted within support structure (housing) 8. Support structure 8 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display modules (projectors) such as display modules 20A and one or more optical systems such as optical systems 20B. Display modules 20A may be mounted in a support structure such as support structure 8. Each display module 20A may emit light 38 (image light) that is redirected towards a user's eyes at eye box 24 using an associated one of optical systems 20B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Display modules 20A may be liquid crystal displays, organic light-emitting diode displays, laser-based displays, or displays of other types. Display modules 20A may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light, etc. Display modules 20A may sometimes also be referred to herein as projectors 20A.

Optical systems 20B may form lenses that allow a viewer (see, e.g., a viewer's eyes at eye box 24) to view images on display(s) 20. There may be two optical systems 20B (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 20B may be selected so that any gap present between the displays will not be visible to a user (e.g., so that the images of the left and right displays overlap or merge seamlessly).

If desired, optical system 20B may contain components (e.g., an optical combiner, etc.) to allow real-world image light from real-world images or objects 28 to be combined optically with virtual (computer-generated) images such as virtual images in image light 38. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement in which a camera captures real-world images of object 28 and this content is digitally merged with virtual content at optical system 20B).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

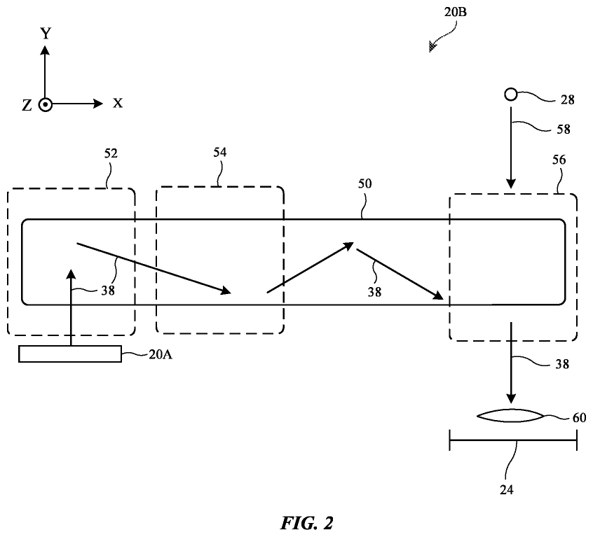

FIG. 2 is a top view of an illustrative display 20 that may be used in system 10 of FIG. 1. As shown in FIG. 2, near-eye display 20 may include one or more display modules such as display module(s) 20A and an optical system such as optical system 20B. Optical system 20B may include optical elements such as one or more waveguides 50. Waveguide 50 may include one or more stacked substrates (e.g., stacked planar and/or curved layers sometimes referred to herein as waveguide substrates) of optically transparent material such as plastic, polymer, glass, etc.

If desired, waveguide 50 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the virtual image. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 50 may include holographic phase gratings such as volume holograms or thin-film holograms, meta-gratings, or any other desired diffractive grating structures. The diffractive gratings on waveguide 50 may also include surface relief gratings formed on one or more surfaces of the substrates in waveguides 50, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 50 if desired.

As shown in FIG. 2, display module 20A may generate image light 38 associated with image content to be displayed to eye box 24 (e.g., image light 38 may convey a series of image frames for display at eye box 24). Image light 38 may be collimated using a collimating lens if desired. Optical system 20B may be used to present image light 38 output from display module 20A to eye box 24. If desired, display module 20A may be mounted within support structure 8 of FIG. 1 while optical system 20B may be mounted between portions of support structure 8 (e.g., to form a lens that aligns with eye box 24). Other mounting arrangements may be used, if desired.

Optical system 20B may include one or more optical couplers (e.g., light redirecting elements) such as input coupler 52, cross-coupler 54, and output coupler 56. In the example of FIG. 2, input coupler 52, cross-coupler 54, and output coupler 56 are formed at or on waveguide 50. Input coupler 52, cross-coupler 54, and/or output coupler 56 may be completely embedded within the substrate layers of waveguide 50, may be partially embedded within the substrate layers of waveguide 50, may be mounted to waveguide 50 (e.g., mounted to an exterior surface of waveguide 50), etc.

Waveguide 50 may guide image light 38 down its length via total internal reflection. Input coupler 52 may be configured to couple image light 38 from display module 20A into waveguide 50, whereas output coupler 56 may be configured to couple image light 38 from within waveguide 50 to the exterior of waveguide 50 and towards eye box 24. Input coupler 52 may include an input coupling prism, an edge or face of waveguide 50, a lens, a steering mirror or liquid crystal steering element, or any other desired input coupling elements. As an example, display module 20A may emit image light 38 in direction +Y towards optical system 20B. When image light 38 strikes input coupler 52, input coupler 52 may redirect image light 38 so that the light propagates within waveguide 50 via total internal reflection towards output coupler 56 (e.g., in direction +X within the total internal reflection (TIR) range of waveguide 50). When image light 38 strikes output coupler 56, output coupler 56 may redirect image light 38 out of waveguide 50 towards eye box 24 (e.g., back along the Y-axis). A lens such as lens 60 may help to direct or focus image light 38 onto eye box 24. Lens 60 may be omitted if desired. In scenarios where cross-coupler 54 is formed on waveguide 50, cross-coupler 54 may redirect image light 38 in one or more directions as it propagates down the length of waveguide 50, for example. In redirecting image light 38, cross-coupler 54 may also perform pupil expansion on image light 38.

Input coupler 52, cross-coupler 54, and/or output coupler 56 may be based on reflective and refractive optics or may be based on diffractive (e.g., holographic) optics. In arrangements where couplers 52, 54, and 56 are formed from reflective and refractive optics, couplers 52, 54, and 56 may include one or more reflectors (e.g., an array of micromirrors, partial mirrors, louvered mirrors, or other reflectors). In arrangements where couplers 52, 54, and 56 are based on diffractive optics, couplers 52, 54, and 56 may include diffractive gratings (e.g., volume holograms, surface relief gratings, etc.).

The example of FIG. 2 is merely illustrative. Optical system 20B may include multiple waveguides that are laterally and/or vertically stacked with respect to each other. Each waveguide may include one, two, all, or none of couplers 52, 54, and 56. Waveguide 50 may be at least partially curved or bent if desired. One or more of couplers 52, 54, and 56 may be omitted. If desired, optical system 20B may include an optical coupler that performs the operations of both cross-coupler 54 and output coupler 56 (sometimes referred to herein as an interleaved coupler, a diamond coupler, or a diamond expander). For example, a surface relief grating structure may redirect image light 38 as the image light propagates down waveguide 50 (e.g., while expanding the image light) and the surface relief grating structure may also couple image light 38 out of waveguide 50 and towards eye box 24.

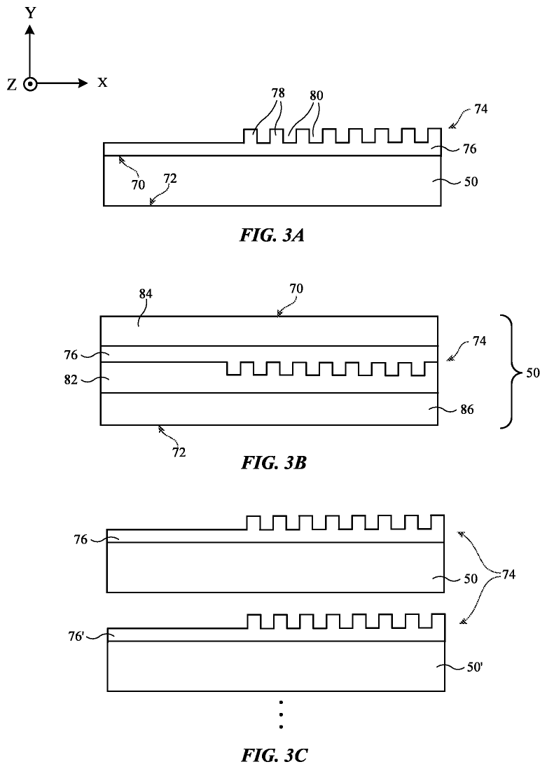

FIG. 3A is a top view showing one example of how a surface relief grating structure may be formed on waveguide 50. As shown in FIG. 3A, waveguide 50 may have a first lateral (e.g., exterior) surface 70 and a second lateral surface 72 opposite lateral surface 70. Waveguide 50 may include any desired number of one or more stacked waveguide substrates. If desired, waveguide 50 may also include a layer of grating medium sandwiched (interposed) between first and second waveguide substrates (e.g., where the first waveguide substrate includes lateral surface 70 and the second waveguide substrate includes lateral surface 72).

Waveguide 50 may be provided with a surface relief grating structure such as surface relief grating structure 74. Surface relief grating (SRG) structure 74 may be formed within a substrate such as a layer of SRG substrate (medium) 76. In the example of FIG. 3A, SRG substrate 76 is layered onto lateral surface 70 of waveguide 50. This is merely illustrative and, if desired, SRG substrate 76 may be layered onto lateral surface 72 (e.g., the surface of waveguide 50 that faces the eye box).

If desired, SRG structure 74 may include one surface relief grating or at least two partially-overlapping surface relief gratings. Each surface relief grating in SRG structure 74 may be defined by corresponding ridges (peaks) 78 and troughs (minima) 80 in the thickness of SRG substrate 76. In the example of FIG. 3A, SRG structure 74 is illustrated for the sake of clarity as a binary structure in which the surface relief gratings in SRG structure 74 are defined either by a first thickness associated with peaks 78 or a second thickness associated with troughs 80. This is merely illustrative. If desired, SRG structure 74 may be non-binary (e.g., may include any desired number of thicknesses following any desired profile, may include peaks 78 that are angled at non-parallel fringe angles with respect to the Y axis, etc.). If desired, SRG substrate 76 may be adhered to lateral surface 70 of waveguide 50 using a layer of adhesive (not shown). SRG structure 74 may be fabricated separately from waveguide 50 and may be adhered to waveguide 50 after fabrication, for example.

The example of FIG. 3A is merely illustrative. In another implementation, SRG structure 74 may be placed at a location within the interior of waveguide 50, as shown in the example of FIG. 3B. As shown in FIG. 3B, waveguide 50 may include a first waveguide substrate 73, a second waveguide substrate 75, and a media layer 82 interposed between waveguide substrate 73 and waveguide substrate 86. Media layer 82 may be a grating or holographic recording medium, a layer of adhesive, a polymer layer, a layer of waveguide substrate, or any other desired layer within waveguide 50. SRG substrate 76 may be layered onto the surface of waveguide substrate 73 that faces waveguide substrate 86. Alternatively, SRG substrate 76 may be layered onto the surface of waveguide substrate 86 that faces waveguide substrate 73.

If desired, SRG structure 74 may be distributed across multiple layers of SRG substrate, as shown in the example of FIG. 3C. As shown in FIG. 3C, the optical system may include multiple stacked waveguides such as at least a first waveguide 50 and a second waveguide 50′. A first SRG substrate 76 may be layered onto one of the lateral surfaces of waveguide 50 whereas a second SRG substrate 76′ is layered onto one of the lateral surfaces of waveguide 50′. First SRG substrate 76 may include one or more of the surface relief gratings in SRG structure 74. Second SRG substrate 76′ may include one or more of the surface relief gratings in SRG structure 74. This example is merely illustrative. If desired, the optical system may include more than two stacked waveguides and/or SRG substrates with one or more respective SRGs. In examples where the optical system includes more than two waveguides, each waveguide that is provided with an SRG substrate may include one or more of the surface relief gratings in SRG structure 74. While described herein as separate waveguides, waveguides 50 and 50′ of FIG. 3C may also be formed from respective waveguide substrates of the same waveguide, if desired. The arrangements in FIGS. 3A, 3B, and/or 3C may be combined if desired.

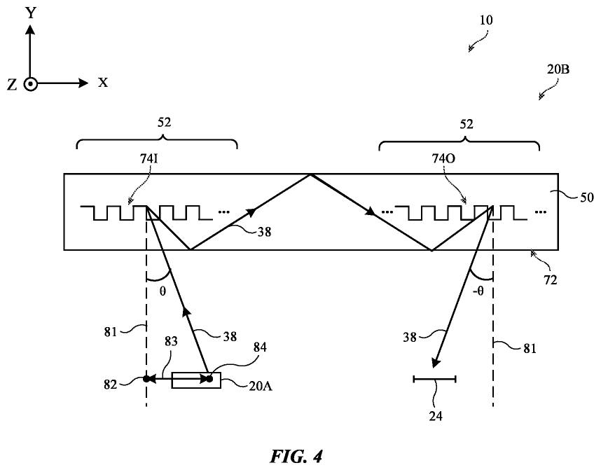

SRG structure 74 may be used to form input coupler 52, cross coupler 54, and/or output coupler 56 of FIG. 2, and/or to form an interleaved coupler on waveguide 50. If desired, SRG structures such as SRG structure 74 may be used to form both an input coupler 52 and an output coupler 56 on waveguide 50. FIG. 4 is a diagram showing how SRG structures may be used to form both input coupler 52 and output coupler 56 on waveguide 50.

As shown in FIG. 4, input coupler 52 on waveguide 50 may include a first surface relief grating structure 74I and output coupler 56 on waveguide 50 may include a second surface relief grating structure 74O. Surface relief grating structure 74I may include one or more overlapping surface relief gratings but is sometimes referred to herein as input coupling surface relief grating 74I or surface relief grating input coupler 74I for the sake of simplicity. Similarly, surface relief grating structure 74O may include one or more overlapping surface relief gratings but is sometimes referred to herein as output coupling surface relief grating 74I or surface relief grating output coupler 74O for the sake of simplicity. Input coupling surface relief grating 74I may be formed in the same layer of SRG medium as output coupling surface relief grating 74O or input coupling surface relief grating 74I and output coupling surface relief grating 74O may be formed in separate layers of SRG medium on waveguide 50.

Input coupling surface relief grating 74I may couple image light 38 from display module 20A into waveguide 50. Output coupling surface relief grating 74O may couple image light 38 out of waveguide 50 at an angle −θ relative to the normal axis (surface) 81 of waveguide 50. Normal axis 81 is orthogonal (perpendicular) to lateral surface 72 of waveguide 50. The magnitude of angle θ may be greater than zero to accommodate the placement of eye box 24 (e.g., eye box 24 may be placed at a location at a user's eyes while the user is wearing system 10 on their head and this location may be misaligned with respect to normal axis 81 at the exit pupil of waveguide 50). As examples, angle θ may be 0-10 degrees, 0-15 degrees, 1-15 degrees, 0-20 degrees, 2-3 degrees, 1-5 degrees, or other angles.

For output coupling surface relief grating 74O to output image light 38 with maximum efficiency at angle −θ, input coupling surface relief grating 74I also needs to receive image light 38 at an incident angle +0 that is equal and opposite to the angle −θ at which output coupling surface relief grating 74O output couples image light 38 (relative to normal axis 81). In other words, input coupling surface relief grating 74I receives image light 38 at an incident angle oriented to a first side of the normal axis and output coupling surface relief grating 74O outputs image light 38 at the same angle but oriented to the opposite (second) side of the normal axis. In diffracting image light 38, input coupling surface relief grating 74I redirects (maps) image light 38 incident parallel to its input vector onto a corresponding output vector that lies within the total internal reflection (TIR) range of waveguide 50 (e.g., where input coupling surface relief grating 74I is characterized by a grating vector extending from the input vector to the output vector). Light incident upon a surface of waveguide 50 from within waveguide 50 at angles within the TIR range of waveguide 50 will propagate down the length of waveguide 50 via TIR.

To provide image light 38 to input coupling surface relief grating 74I at incident angle θ relative to normal axis 81, display module 20A may be mounted at location 84 in system 10. However, location 84 may be too close to eye box 24 such that the housing of system 10 would not be able to fit display module 20A at location 84 (e.g., within a temple portion of the housing in examples where the housing includes a head-mounted device housing) or such that display module 20A would uncomfortably protrude onto a user's head while the user is wearing system 10. If desired, display module 20A may be mounted at location 82, which is located at a further distance 83 from eye box 24 than location 84. This may allow display module 20A to fit within the housing of system 10 more easily and ergonomically (e.g., within a temple portion of the housing without uncomfortably protruding into a user's head) than when display module 20A is at location 84. At the same time, it can be challenging for display module 20A to provide image light 38 to input coupling surface relief grating 74I at incident angle θ when display module 20A is mounted at location 82.

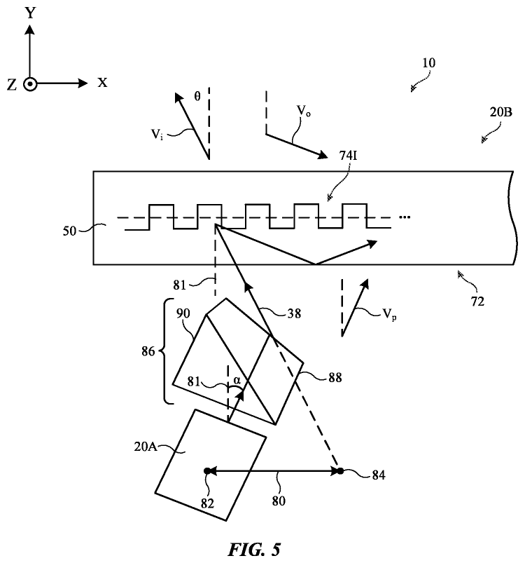

To mitigate these issues, optical system 20B may include a prism or other light redirecting structure that redirects the image light 38 emitted by display 20A while mounted at location 82 onto input coupling surface relief grating 74I at incident angle θ. FIG. 5 is a diagram showing how a prism may redirect the image light 38 emitted by display 20A while mounted at location 82 onto input coupling surface relief grating 74I at incident angle θ.

As shown in FIG. 5, input coupling surface relief grating 74I may be characterized by an input vector Vᵢ and an output vector V_{O}. Input vector Vᵢ may be oriented at angle θ with respect to the normal surface of the waveguide. Output vector V_{O} may be oriented within the TIR range of waveguide 50. Input coupling surface relief grating 74I may also be characterized by a grating vector that extends from the tip of input vector Vᵢ to the tail of output vector V_{O} (e.g., where vectors Vᵢ and V_{I} originate at a common point). Input coupling surface relief grating 74I may diffract (redirect) image light 38 incident parallel to input vector Vᵢ onto a direction parallel to output vector V_{O}, thereby allowing the diffracted image light to propagate down waveguide 50 via total internal reflection.

Display module 20A may be disposed at location 82 within system 10. Display module 20A may be tilted such that the optical axis of display module 20A is oriented at angle α relative to normal axis 81 of waveguide 50. In other words, display module 20A may emit image light 38 in a direction parallel to projector vector V_{P}. The optical axis of display module 20A (projector vector V_{P}) may be separated in angle space from input vector Vᵢ by an angle (e.g., angle θ+α) of around 10-20 degrees, 15 degrees, 5-25 degrees, less than 15 degrees, less than 20 degrees, 14-16 degrees, 12-18 degrees, less than 25 degrees, less than 30 degrees, greater than 5 degrees, or other angles.

A light redirecting element such as prism 86 may be optically interposed between display module 20A and input coupling surface relief grating 74I. Prism 86 may be an achromatic prism and may therefore sometimes be referred to herein as achromatic prism 86. Display module 20A may transmit image light 38 into prism 86. Prism 86 may transmit image light 38 towards input coupling surface relief grating 74I. The geometry and material(s) of prism 86 may be selected to redirect (e.g., refract) image light 38 that is incident parallel to projector vector V_{P} onto an output angle that is parallel to the input vector Vᵢ of input coupling surface relief grating structure 74I. In this way, prism 86 may serve to redirect image light 38 such that image light 38 is incident upon input coupling surface relief grating 74I at the angle θ that allows output coupling surface relief grating 74O to output image light 38 towards eye box 24 at angle −θ (FIG. 4).

Prism 86 may include one or more optical wedges. For example, prism 86 may include a first optical wedge 90 and a second optical wedge 88 stacked or layered onto first optical wedge 90. If desired, first optical wedge 90 may be adhered to second optical wedge 88 using optically clear adhesive. In some examples, optical wedge 90 may be formed from a first material that imparts dispersion on the image light 38 received from display module 20A, in which the optical wedge refracts/disperses the image light at different angles as a function of wavelength. In these examples, optical wedge 88 may be formed from a second material that serves to reverse the dispersion introduced to image light 38 by optical wedge 90. As examples, optical wedge 90 may be formed from calcium fluoride (CaF2) whereas optical wedge 88 is formed from optical glass such as lanthanum-dense glass/flint (e.g., LaSf35) or vice versa, optical wedge 90 may be formed from phosphate crown glass (e.g., PK51) whereas optical wedge 88 is formed from dense flint glass (e.g., Sf1) or vice versa, optical wedge 90 may be formed from lanthanum-dense glass/flint (e.g., LaSF31A) whereas optical wedge 88 is formed from optical glass (e.g., TiF6) or vice versa, etc.

In this way, display module 20A may be placed at location 82, which is located distance 83 farther from the eye box than location 84, rather than at location 84 with the optical axis of display module 20A oriented parallel to input vector Vᵢ, while still allowing image light 38 to be incident upon input coupling surface relief grating 74I at angle θ. This may allow display module 20A to fit within the housing for system 10 without protruding uncomfortably into the user and without sacrificing the optical performance of system 10 in displaying images at eye box 24. The example of FIG. 5 is merely illustrative. If desired, prism 86 may include more than two optical wedges or only a single optical wedge. Additionally or alternatively, non-prism light redirecting structures (e.g., diffractive gratings, mirrors, etc.) may be used to redirect image light 38. Optical wedges 90 and 88 may have other desired shapes.

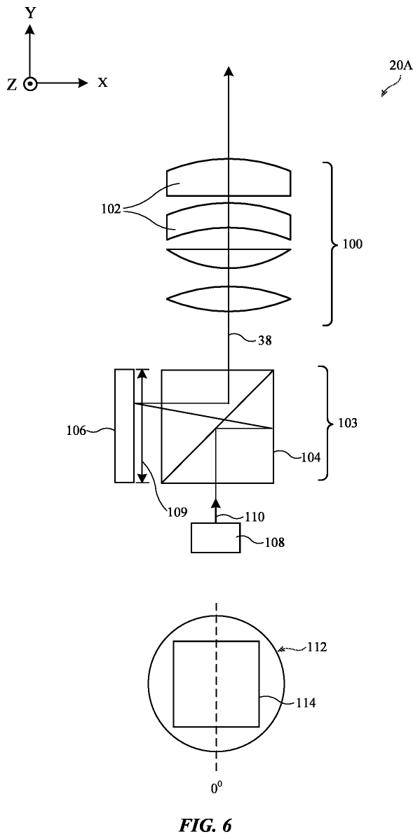

Additionally or alternatively, collimating optics in display module 20A may be offset to provide image light 38 to input coupling surface relief grating 74I at angle θ despite display module 20A being disposed at location 82. FIG. 6 is a diagram of display module 20A having non-offset collimating optics.

As shown in FIG. 6, display module 20A may include illumination optics 108 and spatial light modulator 103. Illumination optics 108 may include one or more light sources such as light emitting diodes (LEDs), organic light emitting diodes (OLEDs), micro LEDs (uLEDs), lasers, etc. The light sources in illumination optics 108 may emit illumination light 110 in one or more wavelength bands (e.g., red, green, and blue bands).

Spatial light modulator 103 may include prism 104 and a reflective display panel such as display panel 106. Display panel 106 may be a DMD panel, an LCOS panel, a ferroelectric liquid crystal on silicon (fLCOS) panel, or other reflective display panel. Prism 104 may direct illumination light 110 onto display panel 106 (e.g., different pixels on display panel 106). Control circuitry 16 (FIG. 1) may control display panel 106 to selectively reflect illumination light 110 at each pixel location to produce image light 38 (e.g., image light having an image as modulated using/onto the illumination light by display panel 106). Prism 104 may direct image light 38 toward collimating optics 100. Collimating optics 100 may direct image light 38 towards the input coupler of waveguide 50 (e.g., collimating optics 100 may focus image light 38 onto an input/entrance pupil of waveguide 50).

The example of FIG. 6 in which display panel 106 is a reflective display panel is merely illustrative. If desired, display panel 106 may be a transmissive display panel that transmits and modulates the illumination light using image data to produce image light 38 (e.g., a transmissive liquid crystal display panel).

Collimating optics 100 may sometimes be referred to herein as collimating lens 100, eyepiece optics 100, or eyepiece 100. Collimating optics 100 may include one or more lens elements 102. Each lens element 102 may have one or more concave surfaces, convex surfaces, spherical surfaces, aspherical surfaces, freeform curved surfaces (e.g., surfaces with curvature that follows any desired three-dimensional freeform curved path that is non-spherical, non-elliptical, etc.), etc. One or more lens elements 102 may impart optical power to image light 38 if desired.

Lens elements 102 may have optical axes aligned with the center of the field of view of display panel 106. For example, as shown in FIG. 6, display panel 106 may have a field of view 112. Image light 38 may have its own field of view 114 centered on the center of field of view 112 of display panel 106. The image light will therefore be incident upon the input coupler on waveguide 50 at an equal number of angles above, below, to the left, and to the right of the center of field of view of the display panel and input coupler.

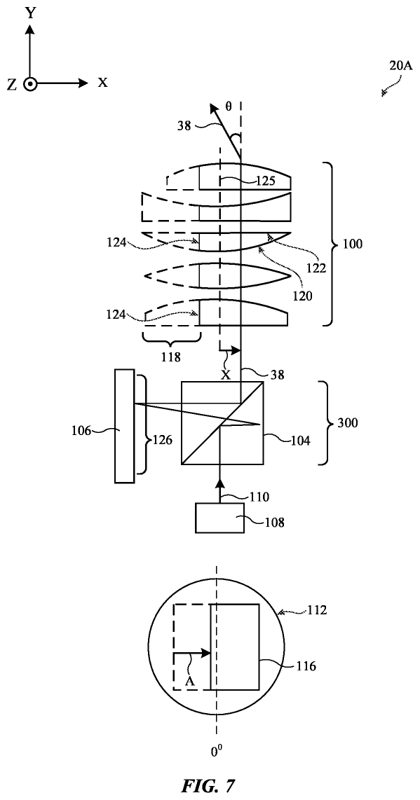

If desired, the lens elements in collimating optics 100 may be offset to output image light 38 that is incident upon input coupling surface relief grating 74I (FIG. 5) at angle θ (e.g., without the need for prism 86 of FIG. 5). FIG. 7 is a diagram showing one example of how the lens elements in collimating optics 100 may be offset to produce image light 38 that is incident upon input coupling surface relief grating 74I at angle θ.

As shown in FIG. 7, collimating optics 100 may include one or more offset lens elements 121. Each lens element 121 may have a first surface 120 and an opposing second surface 122 that transmit image light 38. Each lens element 121 may have an optical axis 125 (e.g., the optical axes of each of the lens elements may be aligned). Optical axis 125 may be offset from the center of image light 38 by offset X. Lens elements 121 may, for example, be enlarged relative to the lens elements 102 of FIG. 6. However, image light 38 only passes through a portion of the lens elements 121 that is offset from optical axis 125 (e.g., with a mean offset X). In other words, there are portions of the lens elements on the opposite of optical axis 125 through which no image light would otherwise pass (e.g., because the lens elements are offset with respect to the field of view and the image light 38 output by prism 104).

Since image light 38 does not pass through all of the area of the lens elements, lens elements 121 may be trimmed or cut to remove portions 118 of lens elements 121 (e.g., image light 38 does not otherwise pass through portions 118). This may serve to minimize the amount of area in display module 20A occupied by lens elements 121 and the weight of display module 20A despite lens elements 121 being larger than the field of view, without affecting optical performance. In this way, each lens element 121 may have a (cut) vertical (planar) sidewall 124 extending between surfaces 122 and 120. Lens elements 121 may exhibit rotational symmetry about optical axis 125 when portions 118 are included. However, removing portions 118 breaks this rotational symmetry of lens elements 121 (e.g., lens elements 121 would exhibit rotational symmetry about optical axis 125 had portions 118 not been removed).

Offsetting lens elements 121 in this way may shift the field of view of image light 38 from field of view 114 of FIG. 6 to field of view 116 of FIG. 7. In other words, offsetting lens elements 121 in this way may shift the field of view of image light 38 away from the center of the field of view 112 of display panel 106 and thus the field of view of the input coupler on waveguide 50 by angular offset A (e.g., an angular offset A corresponding to offset X of FIG. 7). This may cause collimating optics 100 to supply more image light 38 on one side of the center of field of view 112 than on the other. If desired, the entirety of field of view 116 may be located to one side of the center of field of view 112. Angular offset A may be, for example, 5-45 degrees, 5-30 degrees, 10-20 degrees, 5-20 degrees, 12-17 degrees, 15 degrees, 8-22 degrees, 3-28 degrees, etc.

Offsetting lens elements 121 and shifting the field of view of image light 38 in this way may cause image light 38 to be transmitted only by portions of lens elements 121 located on one side of optical axis 125. This may cause collimating optics 100 to transmit image light 38 at angle θ or any other desired angle such that image light 38 is incident upon input coupling surface relief grating 74I at angle θ, thereby allowing prism 86 of FIG. 5 to be omitted if desired. When configured in this way, display module 20A may be located at location 82 of FIG. 5 while still providing image light 38 to input coupling surface relief grating 74I at the angle θ needed to allow output coupling surface relief grating 74O to output image light 38 at angle −θ towards eye box 24. At the same time, the entire area of display panel 106 need not be illuminated using illumination light 110 to produce image light 38 (e.g., since only part of the field of view will be occupied by image light). For example, illumination light 110 may be provided only to region 126 of display panel 106, which is smaller than the length 109 of display panel 106 otherwise required when lens elements 121 are not offset (FIG. 6). This may allow the size of display panel 106 to be reduced relative to the implementation in FIG. 6.

The example of FIG. 7 is merely illustrative. Spatial light modulator 103 may be a transmissive spatial light modulator or modulator 103 and illumination optics 103 may be replaced by an emissive display panel. Collimating optics 100 may have any desired number of lens elements 121 with any desired geometries. Lens elements 121 need not be cut (e.g., portions 118 may remain on lens elements 121). Additionally or alternatively, offsetting lens elements 121 may configure display module 20A to mitigate ghost artifacts produced in waveguide 50.

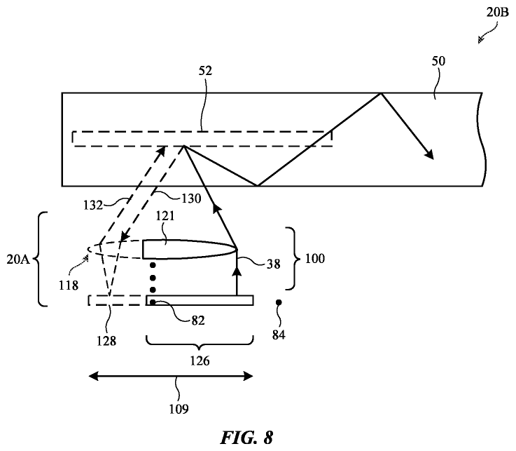

FIG. 8 is a diagram showing how offsetting lens elements 121 may configure display module 20A to mitigate ghost artifacts. As shown in FIG. 8, display panel 106 may provide image light 38 to input coupler 52 on waveguide 50 via collimating optics 100. While a fundamental diffraction mode of input coupler 52 may couple image light 38 into waveguide 50 for propagation via total internal reflection, one or more higher order diffraction modes of input coupler 52 may reflect some of the incident image light 38 back towards display panel 106, as shown by arrow 130.

In implementations where collimating optics 121 are not offset (e.g., in the implementation of FIG. 6), the image light reflected towards display panel 106 by input coupler 52 may hit one or more pixels in an “off” state in region 128 of display panel 106. These pixels may reflect the incident image light back towards the non-offset collimating lens, which may redirect the image light back towards input coupler 52. This may lead to undesirable stray light propagating in waveguide 50 and towards the eye box, which can produce unsightly ghost artifacts or limit the overall contrast of images displayed at the eye box.

However, by offsetting lens elements 121 in collimating optics 100 (e.g., as shown in FIG. 7), portion 128 of display panel 106 (e.g., a portion of display panel 106 outside of region 126) may be removed and portion 118 of lens elements 121 may be removed. This may prevent any reflected image light 38 (e.g., as shown by arrow 130) from hitting pixels in display panel 106 and producing the stray light otherwise associated with arrow 132. In this way, offsetting lens elements 121 may mitigate the production of ghost artifacts and may maximize contrast at the eye box.

In the example of FIG. 8, display module 20A is disposed at location 82. This is merely illustrative and, if desired, display module 20A may be disposed at location 84 and tilted such that the optical axis of display module 20A is oriented at angle θ. When display module 20A is disposed at location 84, lens elements 121 need not be offset because the reflected light associated with arrow 130 would not be incident upon display module 20A. Input coupler 52 may include input coupling surface relief grating 74I or other input couplers (e.g., volume hologram input couplers, input coupling prisms, louvered mirrors, etc.).

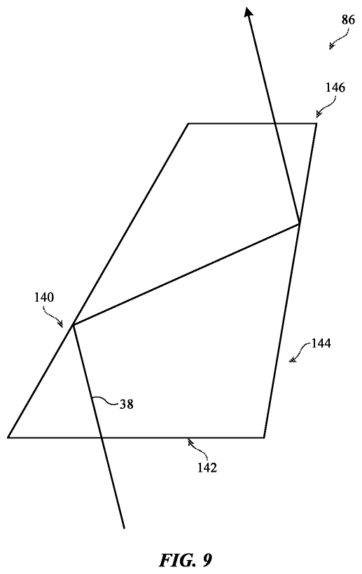

In the example of FIG. 5, prism 86 includes two optical wedges 88 and 90. In other implementations, prism 86 may include a single optical wedge. The optical wedge may have reflective and transmissive surfaces that redirect image light 38 towards the waveguide similar to as shown in FIG. 5. FIG. 9 is a diagram showing how prism 86 may include a single optical wedge.

As shown in FIG. 9, prism 86 may include a single optical wedge. The optical wedge may have at least four surfaces (faces) such as a first surface 142, a second surface 140, a third surface 146, and a fourth surface 144. Prism 86 may receive image light 38 from collimating optics 100 (FIG. 6) through surface 142. Image light 38 may then reflect off surface 140 towards surface 144 (e.g., via total internal reflection). Image light 38 may then reflect off surface 144 towards surface 146 (e.g., via total internal reflection). Prism 86 may transmit image light 38 towards the waveguide through surface 146. In other words, surfaces 142 and 146 may be transmissive surfaces whereas surfaces 140 and 144 are reflective surfaces. If desired, reflective layers may be layered over surface 140 and/or surface 144.

Surfaces 142, 140, 146, and 144 may each be planar or, if desired, one or more of surfaces 142, 140, 146, and 144 may be curved (e.g., freeform curved, biconically curved, spherically curved, etc.). Curving the surfaces may, for example, impart optical power to image light 38 upon reflection or transmission by the surfaces. As one example, surfaces 142 and 146 may be curved (e.g., with the same curvature to impart the same optical power). Prism 86 may, if desired, be formed from injection molded plastic in examples where one or more of the surfaces are curved. Prism 86 of FIG. 9 may have the same light redirecting effect as the prism 86 having multiple optical wedges (FIG. 5). Since prism 86 is formed from a single material, prism 86 may introduce dispersion to the image light if care is not taken. If desired, the SRG used to form the input coupler may have a pitch that is adjusted to correct for chromatic aberration from prism 86. If desired, additional elements may be interposed along the optical path to correct for the dispersion (e.g., for each color). The example of FIG. 9 is merely illustrative and, in general, prism 86 may have other shapes. Prism 86 of FIG. 9 may sometimes be referred to herein as a compound fold prism.

In accordance with an embodiment, a display is provided that includes a waveguide configured to propagate light via total internal reflection, a first surface relief grating configured to couple the light into the waveguide, the first surface relief grating having an input vector, a projector configured to output the light at an angle non-parallel with respect to the input vector, a prism optically coupled between the projector and the waveguide, the prism is configured to redirect the light from the projector to the first surface relief grating in a direction parallel to the input vector, and a second surface relief grating configured to couple the light out of the waveguide.

In accordance with another embodiment, the prism includes an achromatic prism.

In accordance with another embodiment, the prism includes a first optical wedge and a second optical wedge on the first optical wedge, the first and second optical wedges being configured to transmit the light, the first optical wedge includes a first material, and the second optical wedge includes a second material that is different from the first material.

In accordance with another embodiment, the angle and the input vector are separated by 5-25 degrees.

In accordance with another embodiment, the waveguide includes a lateral surface, the angle and the input vector are each non-parallel with respect to a normal axis of the lateral surface, the light is incident on the first surface relief grating at an additional angle with respect to a first side of the normal axis, and the second surface relief grating is configured to output the light at the additional angle with respect to a second side of the normal axis.

In accordance with another embodiment, the prism includes an optical wedge having a first surface that transmits the light into the prism, a second surface, a third surface, and a fourth surface that transmits the light out of the prism, the second surface reflects the light towards the third surface, and the third surface reflects the light towards the fourth surface.

In accordance with another embodiment, one or more of the first, second, third, and fourth surfaces is curved.

In accordance with another embodiment, the display includes, the waveguide includes a first media layer, the first surface relief grating is in the first media layer, and a second media layer that is different from the first media layer, the second surface relief grating is in the second media layer.

In accordance with another embodiment, the display includes, the waveguide including a media layer, the first and second surface relief gratings are in the media layer.

In accordance with an embodiment, a display is provided that includes a waveguide configured to propagate light via total internal reflection, a first surface relief grating configured to couple the light into the waveguide, the first surface relief grating being characterized by an input vector, a display panel configured to produce the light based on image data, the light has a field of view, and optics coupled between the display panel and the waveguide, the optics include: a lens configured to transmit the light towards the first surface relief grating and having an optical axis that is offset at a non-zero angle with respect to a center of the field of view of the light, the optical axis is oriented at a non-zero angle with respect to the input vector, and the optics are configured to output the light in a direction parallel to the input vector.

In accordance with another embodiment, the display includes, the optics including an additional lens configured to transmit the light and having an optical axis aligned with the optical axis of the lens.

In accordance with another embodiment, the lens has a first surface that transmits the light, a second surface opposite the first surface that transmits the light, and a planar surface couples the first surface to the second surface, the planar surface being located on a side of the optical axis opposite to the center of the field of view of the light.

In accordance with another embodiment, the waveguide includes a lateral surface and the optical axis is oriented parallel to a normal axis of the lateral surface.

In accordance with another embodiment, the waveguide has a lateral surface, the light is incident on the first surface relief grating at an angle with respect to a first side of a normal axis of the lateral surface, and the second surface relief grating is configured to output the light at the angle with respect to a second side of the normal axis.

In accordance with another embodiment, the display panel includes a display panel selected from the group consisting of: a digital micromirror device (DMD) display panel, a liquid crystal on silicon (LCOS) display panel, a ferroelectric liquid crystal on silicon (fLCOS) display panel, and a transmissive liquid crystal display panel.

In accordance with another embodiment, the display includes, the waveguide including a first media layer, the first surface relief grating is in the first media layer, and a second media layer that is different from the first media layer, the second surface relief grating is in the second media layer.

In accordance with another embodiment, the display includes, the waveguide including a media layer, the first and second surface relief gratings are in the media layer.

In accordance with another embodiment, the non-zero angle is between 5 degrees and 30 degrees.

In accordance with an embodiment, a display is provided that includes a waveguide configured to propagate light via total internal reflection, an input coupler having a diffractive grating configured to couple the light into the waveguide, illumination optics configured to emit illumination, a reflective display panel configured to produce the light by modulating the illumination, and a lens configured to transmit the light to the input coupler and having an optical axis that is offset at a non-zero angle with respect to a center of a field of view of the light, the lens is configured to output the light in a direction parallel to an input vector of the diffractive grating.

In accordance with another embodiment, the waveguide has a lateral surface and the optical axis is oriented parallel to a normal axis of the lateral surface.

In accordance with another embodiment, the waveguide has a lateral surface and the optical axis is oriented at a non-parallel angle with respect to a normal axis of the lateral surface.

The foregoing is merely illustrative and various modifications can be made to the described embodiments. The foregoing embodiments may be implemented individually or in any combination.

What is claimed is:

1. A display comprising:
a waveguide configured to propagate light via total internal reflection;
a first surface relief grating configured to couple the light into the waveguide, the first surface relief grating having an input vector;
a projector configured to output the light at an angle non-parallel with respect to the input vector;
a prism optically coupled between the projector and the waveguide, wherein the prism is configured to redirect the light from the projector to the first surface relief grating in a direction parallel to the input vector; and
a second surface relief grating configured to couple the light out of the waveguide.

2. The display of claim 1, wherein the prism comprises an achromatic prism.

3. The display of claim 1, wherein the prism comprises a first optical wedge and a second optical wedge on the first optical wedge, the first and second optical wedges being configured to transmit the light, the first optical wedge comprises a first material, and the second optical wedge comprises a second material that is different from the first material.

4. The display of claim 1, wherein the angle and the input vector are separated by 5-25 degrees.

5. The display of claim 1, wherein the waveguide comprises a lateral surface, the angle and the input vector are each non-parallel with respect to a normal axis of the lateral surface, the light is incident on the first surface relief grating at an additional angle with respect to a first side of the normal axis, and the second surface relief grating is configured to output the light at the additional angle with respect to a second side of the normal axis.

6. The display of claim 1, wherein the prism comprises an optical wedge having a first surface that transmits the light into the prism, a second surface, a third surface, and a fourth surface that transmits the light out of the prism, the second surface reflects the light towards the third surface, and the third surface reflects the light towards the fourth surface.

7. The display of claim 6, wherein one or more of the first, second, third, and fourth surfaces is curved.

8. The display of claim 1, the waveguide comprising:
a first media layer, wherein the first surface relief grating is in the first media layer; and
a second media layer that is different from the first media layer, wherein the second surface relief grating is in the second media layer.

9. The display of claim 1, the waveguide comprising:
a media layer, wherein the first and second surface relief gratings are in the media layer.

10. A display comprising:
a waveguide configured to propagate light via total internal reflection;
a first surface relief grating configured to couple the light into the waveguide, the first surface relief grating being characterized by an input vector;
a display panel configured to produce the light based on image data, wherein the light has a field of view; and
optics coupled between the display panel and the waveguide, the optics comprising:
a lens configured to transmit the light towards the first surface relief grating and having an optical axis that is offset at a non-zero angle with respect to a center of the field of view of the light, wherein the optical axis is oriented at a non-zero angle with respect to the input vector, and wherein the optics are configured to output the light in a direction parallel to the input vector.

11. The display of claim 10, the optics further comprising:
an additional lens configured to transmit the light and having an optical axis aligned with the optical axis of the lens.

12. The display of claim 10, wherein the lens has a first surface that transmits the light, a second surface opposite the first surface that transmits the light, and a planar surface couples the first surface to the second surface, the planar surface being located on a side of the optical axis opposite to the center of the field of view of the light.

13. The display of claim 10, wherein the waveguide comprises a lateral surface and wherein the optical axis is oriented parallel to a normal axis of the lateral surface.

14. The display of claim 10, wherein the waveguide has a lateral surface, the light is incident on the first surface relief grating at an angle with respect to a first side of a normal axis of the lateral surface, and the second surface relief grating is configured to output the light at the angle with respect to a second side of the normal axis.

15. The display of claim 10, wherein the display panel comprises a display panel selected from the group consisting of: a digital micromirror device (DMD) display panel, a liquid crystal on silicon (LCOS) display panel, a ferroelectric liquid crystal on silicon (fLCOS) display panel, and a transmissive liquid crystal display panel.

16. The display of claim 10, the waveguide comprising:
a first media layer, wherein the first surface relief grating is in the first media layer; and
a second media layer that is different from the first media layer, wherein the second surface relief grating is in the second media layer.

17. The display of claim 10, the waveguide comprising:
a media layer, wherein the first and second surface relief gratings are in the media layer.

18. The display of claim 10, wherein the non-zero angle is between 5 degrees and 30 degrees.

19. A display comprising:
a waveguide configured to propagate light via total internal reflection;
an input coupler having a diffractive grating configured to couple the light into the waveguide;
illumination optics configured to emit illumination;
a reflective display panel configured to produce the light by modulating the illumination; and
a lens configured to transmit the light to the input coupler and having an optical axis that is offset at a non-zero angle with respect to a center of a field of view of the light, wherein the lens is configured to output the light in a direction parallel to an input vector of the diffractive grating.

20. The display of claim 19, wherein the waveguide has a lateral surface and wherein the optical axis is oriented parallel to a normal axis of the lateral surface.

21. The display of claim 19, wherein the waveguide has a lateral surface and wherein the optical axis is oriented at a non-parallel angle with respect to a normal axis of the lateral surface.
